(19) United States
(12) Patent Application Publication
(10) Pub. No.: US 2024/0104929 A1
(43) Pub. Date: Mar. 28, 2024

(54) INFORMATION PROCESSING DEVICE AND INFORMATION PROCESSING METHOD

(71) Applicant: Toshiba Tec Kabushiki Kaisha, Tokyo (JP)

(72) Inventor: Ryuzo YAMAMOTO, Izunokuni Shizuoka (JP)

(21) Appl. No.: 18/359,853

(22) Filed: Jul. 26, 2023

(30) Foreign Application Priority Data
Sep. 22, 2022 (JP) 2022-151472

(51) Int. Cl. G06V 20/52; G06V 10/24; G06V 40/20

(52) U.S. Cl. CPC G06V 20/52; G06V 10/24; G06V 40/28

(57) ABSTRACT

According to one embodiment, an information processing device for analysis of images from a camera positioned to view a checkout apparatus includes a control unit. The control unit is configured to perform an analysis of a first sub-area of images from the camera to detect a movement of an operator or merchandise at the checkout apparatus. The control unit outputs a notification of non-registration if the analysis of the first sub-area of the images indicates that an item of merchandise has arrived at a post-registration storage place of the checkout apparatus from a pre-registration storage place of the checkout apparatus without passing through a registration region. The control unit adjusts a boundary position between the first sub-area and a periphery area in the images from the camera based on how often the operator or the merchandise is detected as crossing the boundary position.

### CROSS-REFERENCE TO RELATED APPLICATION

This application is based upon and claims the benefit of priority from Japanese Patent Application No. 2022-151472, filed Sep. 22, 2022, the entire contents of which are incorporated herein by reference.

### FIELD

Embodiments described herein relate generally to an information processing device and an information processing method for point-of-sale systems in retail stores and the like.

### BACKGROUND

In the related art, a self-service-type POS (point of sales) terminal where a shopper (customer) carries out operations for registration processing and settlement processing for merchandise being purchased or a semi-self-service-type POS terminal where a shopper carries out an operation for settlement processing after merchandise registration, are known. Such a POS terminal can have a camera picking up an image of the customer, analyzes the image from the camera, and thus can possibly detect an operation error or an unauthorized action by the customer. In this regard, the related art discloses a technique of extracting a line of movement of a person in a designated area by output from the camera.

In the analysis of the picked-up image, the load on the processing unit performing such analysis becomes higher as the volume of the image data becomes greater. To restrain the load on the processing unit, it is desirable to make the volume of the image data as small as possible. However, in the current situation, to find an inappropriate action in sales data processing, generally no measures for restraining the volume of the image data used for the analysis are taken and the entirety of the picked-up images output from the camera is analyzed.

### BRIEF DESCRIPTION OF THE DRAWINGS

FIG. 1 is a perspective view of a self-service POS terminal according to an embodiment, as viewed from an operator side.

FIG. 2 shows an example of the hardware configuration of a self-service POS terminal.

FIG. 3 shows an example of the hardware configuration of a server.

FIG. 4 depicts certain functional aspects of a self-service POS terminal and a server.

FIG. 5 shows an example of a picked-up image from a camera.

FIG. 6 shows an example of a picked-up image.

FIG. 7 is a flowchart showing an example of processing executed by a server.

### DETAILED DESCRIPTION

An embodiment described herein provides an information processing device and an information processing method that can limit the processing load required for image analysis to detect an inappropriate action by an operator during sales data processing.

In general, according to one embodiment, an information processing device for image analysis of images from a camera positioned to image an operation at a checkout apparatus includes a control unit. The control unit is configured to perform an analysis of a first sub-area of images from a camera to detect a movement of an operator or merchandise at a checkout apparatus, output a notification of non-registration if the analysis of the first sub-area of the images indicates that an item of merchandise has arrived at a post-registration storage place of the checkout apparatus from a pre-registration storage place of the checkout apparatus without passing through a registration region, and adjust a boundary position between the first sub-area and a periphery area in the images from the camera based on how often the operator or the merchandise is detected as crossing the boundary position.

### First Embodiment

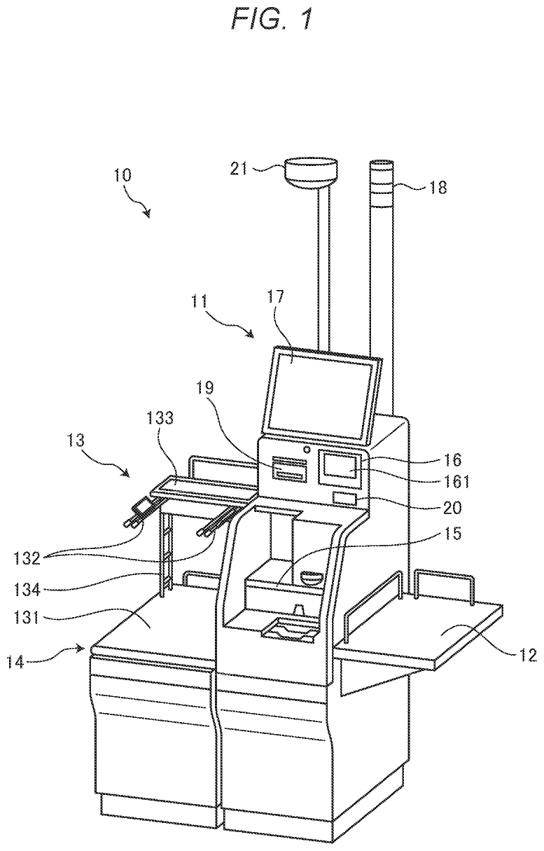

An embodiment will now be described using the drawings. FIG. 1 is a perspective view showing an example of the external appearance of a self-service POS terminal 10, as viewed from an operator side. The self-service POS terminal 10 is an example of a sales data processing device processing information used for a merchandise transaction (sales transaction). In this example, self-service POS terminal 10 is a POS (point of sales) terminal where a shopper acts as an operator and carries out processing for the registration and settlement (payment) for the merchandise being purchased.

The self-service POS terminal 10 has a main body 11, a basket placing table 12, and a bagging table 13. The main body 11 is provided between the basket placing table 12 and the bagging table 13. The basket placing table 12 is for placing a basket or the like in which transaction target merchandise has been put therein. The bagging table 13 is where a shopping bag can be hooked in an open state. An item of registered merchandise is put into the shopping bag after being removed from the basket placing table 12 and registered in the transaction. That is, the now registered merchandise is placed on the bagging table 13.

The bagging table 13 has a pedestal 131, a bag hook 132, and a temporary placing table 133. The bag hook 132 and the temporary placing table 133 are supported by a support pole 134 provided on the pedestal 131 and are thus provided above the pedestal 131. The bag hook 132 is a hook on which a bag for a registered merchandise can be suspended. The pedestal 131 is a table that supports the bottom of the bag and on which, for example, any merchandise that is larger than the bag and therefore unsuitable to be put in the bag, or the like, may be placed. The temporary placing table 133 is a table on which, for example, a type of merchandise that needs extra care at the time of bagging because of fragility or the like can be temporarily placed.

The self-service POS terminal 10 also has a measurement unit 14, a deposit and withdrawal unit 15, a scanner 16, a touch panel display 17, an indication lamp 18, a card reader 19, a printer 20, and a camera 21.

The measurement unit 14 is provided for the bagging table 13. The measurement unit 14 measures the weight of an object such as a merchandise placed on the bagging table 13 based on an output from a built-in weight sensor. For example, the measurement unit 14 measures the total weight of the bag set on the bagging table 13 and the merchandise put in the bag, or the like. The weight sensor is provided, for example, below the pedestal 131, supports the pedestal 131, and outputs a signal corresponding to a load received by the pedestal 131.

The deposit and withdrawal unit 15 is provided, for example, at a center part in an up-down direction of the main body 11. The deposit and withdrawal unit 15 accepts the input of a coin or a banknote being paid by the shopper and discharges change as necessary. If, for example, the self-service POS terminal 10 is configured as a cashless terminal that does not handle cash, or the like, the deposit and withdrawal unit 15 may be not provided.

The scanner 16 is provided, for example, at an upper part of the main body 11. The scanner 16 has a reading window 161. The scanner 16 reads merchandise information from a wireless tag or a code symbol, such as a barcode, attached to an item of merchandise when held in front of the reading window 161. The wireless tag is an electronic tag such as an RF (radio frequency) tag (e.g., RFID tag). The wireless tag has an IC (integrated circuit) chip, storing information, and an antenna. The wireless tag transmits tag information stored in the IC chip in response to a radio wave received from a wireless tag reading device. For example, the merchandise information for the merchandise to which the wireless tag attached is stored in the wireless tag. The merchandise information includes, for example, a merchandise code that can identify the merchandise.

The scanner 16 may have a camera configured to pick up an image of the merchandise held in front of the reading window 161. The camera of the scanner 16 can be, for example, an image pickup element such as a CMOS (complementary metal-oxide semiconductor) or CCD (charge-coupled device). The reading window 161 can transmit light. Image data of the merchandise picked up by the camera can be provided for object recognition processing by an image processing device. Thus, the merchandise included in the image data can be identified and registered. The image processing device is, for example, an external device communicatively connected to the self-service POS terminal 10 via a communication I/F (interface). The object recognition processing may be executed by the self-service POS terminal 10 itself or otherwise.

The touch panel display 17 is provided, for example, above the main body 11. The touch panel display 17 displays various information for the operator (customer) on a screen and accepts an input operation from the operator (customer).

The indication lamp 18 is provided, for example, at the back of the main body 11. The indication lamp 18 is an electric lamp that notifies a salesclerk that an abnormality or the like has occurred at the self-service POS terminal 10.

The card reader 19 is provided, for example, to one side of the scanner 16 in the main body 11. The card reader 19 reads information stored in a card such as a credit card.

The printer 20 is provided, for example, inside the casing of the main body 11. The printer 20 is a printing device that prints a receipt showing details of a transaction and/or a coupon for a discount or the like for merchandise or the like. The printer 20 has a receipt discharge section at the front of the main body 11. The receipt discharge section is a discharge port for discharging the receipt or the like dispensed by the printer 20 to outside the self-service POS terminal 10. The receipt discharge section is provided, for example, between the deposit and withdrawal unit 15 and the scanner 16 in the main body 11.

The camera 21 is a camera configured to pick up an image of an area where the operator of the self-service POS terminal 10 is seen. The camera 21 includes, for example, an image pickup element such as a CMOS or a CCD. Image data outputted from the camera 21 by image pickup is provided for analysis processing by an analysis unit 311 (described later).

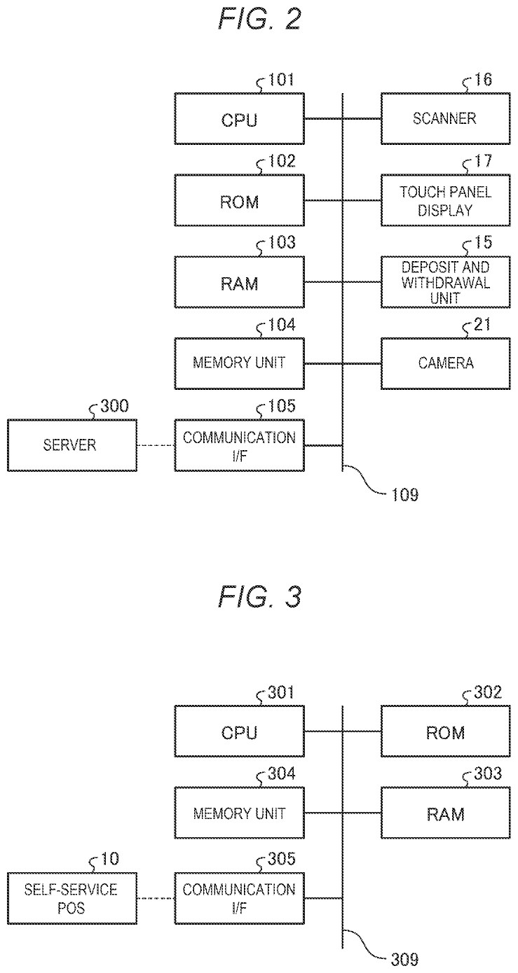

FIG. 2 shows an example of the hardware configuration of the self-service POS terminal 10 according to the embodiment. The self-service POS terminal 10 has a CPU (central processing unit) 101, a ROM (read-only memory) 102, a RAM (random-access memory) 103, a memory unit 104, and a communication I/F (interface) 105.

The measurement unit 14, the deposit and withdrawal unit 15, the scanner 16, the touch panel display 17, the indication lamp 18, the card reader 19, the printer 20, the camera 21, the CPU 101, the ROM 102, the RAM 103, the memory unit 104, and the communication I/F 105 are connected to each other via a system bus 109 such as a data bus or an address bus.

The memory unit 104 is a memory device such as an HDD (hard disk drive), an SSD (solid-state drive) or a flash memory. The memory unit 104 stores a control program and a merchandise master or the like. The control program is an operating program or a program for implementing various functions provided by the self-service POS terminal 10.

The merchandise master stores information about items of merchandise (merchandise information) in correlation with a merchandise code, which is identification information that can identify the merchandise. The merchandise information includes, for example, the name of the merchandise, the price, the expected weight value of the merchandise, and the like. If the self-service POS terminal 10 is a type that executes object recognition processing, information about feature data (feature values) for object comparison (collation) may be provided as the merchandise information in the merchandise master. The feature data for collation is information representing the features of the external appearance of the item of merchandise. The feature data can be a parameter related to aspects such as the standard shape of the merchandise, the color tone of the surface, the design pattern, or the surface roughness state.

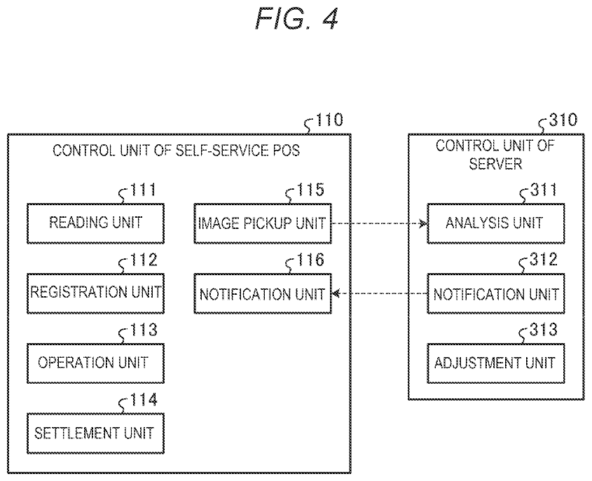

The CPU 101 is a processor. The ROM 102 is a memory medium storing various programs and data. The RAM 103 is a memory medium temporarily storing various programs and various data. The CPU 101 executes various programs stored in the ROM 102 or the memory unit 104 or the like, using the RAM 103 as a work area, and thus implements a control unit 110 (see FIG. 4). The control unit 110 manages and controls each part of the self-service POS terminal 10.

The processor of the control unit 110 is not limited to a CPU 101. Other processors such as a GPU (graphics processing unit), an ASIC (application-specific integrated circuit), and an FPGA (field-programmable gate array) may be used instead or in combination.

The communication I/F 105 is an interface for the self-service POS terminal 10 to communicate with an external device via a network. An example of the external device is a server 300. The server 300 is an example of an information processing device that analyzes a picked-up image from the camera 21.

As another external device, an information processing device (hereinafter referred to as a management device) operated by a manager such as a salesclerk monitoring the self-service POS terminal 10 may be employed. The management device is, for example, a PC (personal computer), a tablet terminal, a smartphone or the like. The management device is connected, for example, to a plurality of self-service POS terminals 10. Also, in some examples, any self-service POS terminal 10 of a plurality of self-service POS terminals 10 connected to each other via a network can be used as the management device. The management device notifies the salesclerk of the detection of an unauthorized action, based on notification information from a self-service POS terminal 10.

As still another external device, an image processing device that executes image processing such as object recognition processing can be employed.

FIG. 3 shows an example of the hardware configuration of the server 300 according to the embodiment. The server 300 has a CPU 301, a ROM 302, a RAM 303, a memory unit 304, and a communication I/F 305. These components are connected to each other via a system bus 309 such as a data bus or an address bus.

The memory unit 304 is a memory device such as an HDD, an SSD, or a flash memory. The memory unit 304 stores a control program or the like. The control program is an operating program or a program for implementing various functions provided in the server 300.

The CPU 301 is a processor. The ROM 302 is a memory medium storing various programs and data. The RAM 303 is a memory medium temporarily storing various programs and various data. The CPU 301 executes various programs stored in the ROM 302 or the memory unit 304 or the like, using the RAM 303 as a work area, and thus implements a control unit 310 (see FIG. 4). The control unit 310 manages and controls each part of the server 300.

The processor of the control unit 310 is not limited to the CPU 301. Other processors such as a GPU (graphics processing unit), an ASIC (application-specific integrated circuit), and an FPGA (field-programmable gate array) may be used instead or in combination.

FIG. 4 shows an example of the functional configuration of the self-service POS terminal 10 and the server 300 according to an embodiment.

The control unit 110 of the self-service POS terminal 10 functions as a reading unit 111, a registration unit 112, an operation unit 113, a settlement unit 114, an image pickup unit 115, and a notification unit 116. The control unit 310 of the server 300 functions as an analysis unit 311, a notification unit 312, an adjustment unit 313, or the like.

A some or all of the functions implemented by the control unit 310 of the server 300 in this embodiment may instead be implemented by the control unit 110 of the self-service POS terminal 10, or may be implemented in cooperation with the self-service POS terminal 10, or may be implemented by a hardware component such as a dedicated circuit installed in the self-service POS terminal 10 or otherwise.

The reading unit 111 of the self-service POS terminal 10 is an input unit that accepts an input of information about transaction target merchandise. The reading unit 111 reads a merchandise code from a wireless tag or a code symbol such as a barcode attached to the merchandise, via the scanner 16, and outputs the merchandise code. The reading unit 111 may identify the merchandise by object recognition based on image data picked up by the camera of the scanner 16.

The registration unit 112 acquires information (merchandise information) from the merchandise master, based on the merchandise code from the reading unit 111, and registers the acquired merchandise information. Registering the acquired merchandise information in this case means storing the acquired merchandise information as sales data in a predetermined memory area (provided, for example, in the memory unit 104). The registration unit 112 may register an item of merchandise specified by an operation input manually to the touch panel display 17, instead of the merchandise information from the reading unit 111.

The operation unit 113 is an input unit that accepts an input of information about a transaction target merchandise. The operation unit 113 accepts an operation from the operator. More specifically, the operation unit 113 outputs a signal corresponding to an operation input received by the touch panel display 17.

The settlement unit 114 performs processing (settlement processing) for the settlement for the merchandise registered by the registration unit 112. For example, the settlement unit 114 calculates the total amount of the price of the merchandise registered by the registration unit 112. The settlement unit 114 also subtracts the total amount from the amount inserted in the deposit and withdrawal unit 15 and thus calculates change. The settlement unit 114 then causes the deposit and withdrawal unit 15 to discharge the change.

The image pickup unit 115 picks up, with the camera 21, an image of an area where the operator of the self-service POS terminal 10 can be seen, and outputs the image. More specifically, the image pickup unit 115 controls the camera 21 and thus outputs (transmits) a picked-up image outputted from the camera 21 to the server 300 or the like. The area where the operator of the self-service POS terminal 10 is located is an area including a position assumed to be where the operator will be present during operation. This area is approximately opposite the operation unit 113 and in front of the self-service POS terminal 10.

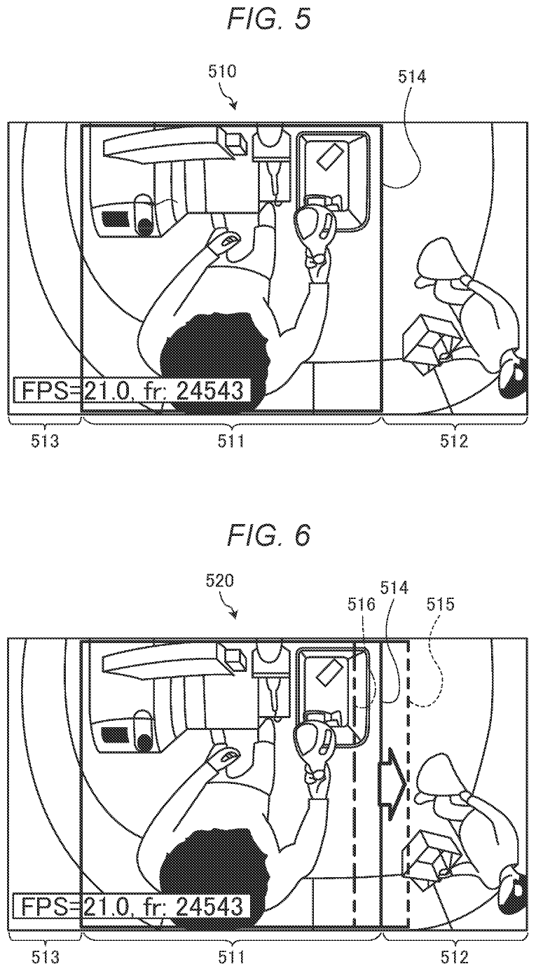

The analysis unit 311 of the server 300 executes processing (analysis processing) of analyzing the picked-up images from the camera 21. The analysis unit 311 analyzes a first area 511 in the image data from the camera 21 and outputs information about the movement of the operator according to the image data. In this respect, FIG. 5 shows an example of a picked-up image 510 from the camera 21 according to the embodiment.

The picked-up image 510 is divided into a plurality of areas and includes the first area 511, a second area 512, and a third area 513. The first area 511 is set at a center part of the picked-up image 510. The initial value of this first area 511 is typically set by maintenance staff (technical staff) when installing the self-service POS terminal 10. The maintenance staff sets the first area 511 in the picked-up image 510 by referring to the output from the camera 21. This initial setting is stored, for example, in the memory unit 304.

The second area 512 and the third area 513 are parts of the picked-up image 510 outside the first area 511 and are areas determined by the maintenance staff as unnecessary or non-essential for image analysis. The third area 513 is an area on which image analysis is not performed.

The second area 512 is a part of the image data and adjacent to the first area 511 at a boundary 514. In the second area 512 in this embodiment, a shopper (person waiting) who seems to be waiting for his or her turn to use the self-service POS terminal 10 is seen.

In the foregoing description, the “information about the movement of the operator” from the analysis unit 311 can be acquired by performing a behavior detection using a skeleton estimation technique. A specific example of this information is first, second, and third information, to be described below.

The first information is information representing the detection of a non-registration. The analysis unit 311 performs behavior detection based on skeleton estimation, using the image included in the first area 511 of the picked-up image 510. When it can be determined that the merchandise has arrived at a post-registration storage place (bagging table 13) without passing through a position for accepting a registration operation (vicinity of the front of the scanner 16) from a pre-registration storage place (basket placing table 12) in the self-service POS terminal 10, based on the movement path of the estimated skeleton of the shopper, the analysis unit 311 determines that a non-registration is detected, and outputs the first information to that effect.

The second information is the number of times the estimated skeleton has intersected the boundary 514 between the first area 511 and the periphery thereof (second area 512). The analysis unit 311 counts the number of times the estimated skeleton of the shopper has intersected the boundary 514, and records this number of times in a predetermined area in the memory unit 304, or the like.

As the third information, the duration of a state where the estimated skeleton does not go beyond an imaginary line 516 set inside the first area 511 is measured and recorded in a predetermined area in the memory unit 304, or the like. The line 516 is set at a position at a predetermined distance from the boundary 514.

The notification unit 312 outputs information for notifying the salesclerk or the like of non-registration, based on the first information from the analysis unit 311. More specifically, if the analysis unit 311 outputs information representing the detection of non-registration, the notification unit 312 receives this information and transmits a notification to the self-service POS terminal 10 and the management device.

The adjustment unit 313 adjusts the position of the boundary 514 of the first area 511, based on the second and third information output from the analysis unit 311. In this respect, FIG. 6 shows an example of a picked-up image 520 from the camera 21 according to the embodiment. The “adjustment” is intended to make a change to achieve a state that is determined as preferable, based on a predetermined criterion.

For example, the adjustment unit 313 makes an adjustment to broaden the first area 511 if it is determined that the frequency at which an arm or a hand of the operator in motion intersects the boundary 514 of the first area 511 is high, based on the output (second information) from the analysis unit 311.

Specifically, the adjustment unit 313 moves the boundary 514 to a predetermined position 515. The position 515 is located in the second area 512 adjacent to the first area 511 and at a predetermined distance from the boundary 514.

In the foregoing determination, the adjustment unit 313 determines that “the frequency is high”, for example, if the frequency of occurrence of an event where the skeleton estimated by the analysis unit 311 and the boundary 514 intersect each other exceeds a predetermined threshold. The foregoing frequency is the number of times the event occurs within a predetermined period of time.

Also, if it is determined that a state where the arm or the hand of the operator in motion does not go beyond the foregoing line 516 continues, based on the output (third information) from the analysis unit 311, the adjustment unit 313 makes an adjustment to narrow the first area 511 to the line 516 (move the boundary 514 to the position of the line 516).

In the foregoing determination, the adjustment unit 313 determines that “the foregoing state continues”, for example, if the third information, that is, the duration of the state where the skeleton estimated by the analysis unit 311 does not intersect the foregoing line 516, exceeds a predetermined threshold.

Such an adjustment can make the first area 511 as narrow as possible to such an extent that the skeleton of the shopper who is the operator of the self-service POS terminal 10 does not intersect the boundary 514. Thus, the state where the skeleton estimated by the analysis unit 311 does not go out of the first area 511 can be maintained and also the state where the load due to the image analysis is reduced can be maintained.

The analysis unit 311 also analyzes the second area 512 and thus outputs fourth information representing whether there is a person waiting to use the self-service POS terminal 10 or not, and the number of people waiting. This processing can be executed when the control unit 310 has a sufficient spare capacity. This processing is omitted when the capacity of the control unit 310 is under strain.

Referring back to FIG. 4, the notification unit 116 receives the notification of the detection of non-registration from the server 300 and thus activates the indication lamp 18 and transmits a notification to the management device.

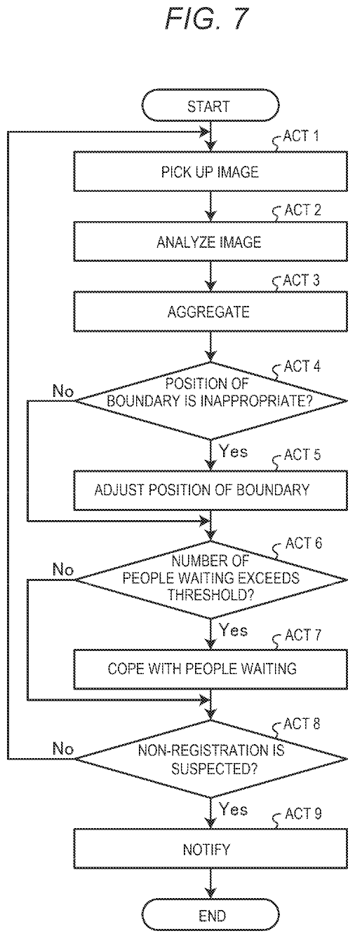

FIG. 7 is a flowchart showing an example of the processing executed by the server 300 according to the embodiment.

The control unit 310 receives a picked-up image from the camera 21 (ACT 1) and then performs image analysis as the analysis unit 311 and thus acquires the first to fourth information (ACT 2).

Next, the control unit 310 performs aggregation based on the second and third information (ACT 3).

Next, the control unit 310 determines whether the position of the boundary 514 is appropriate or not, based on the result of the aggregation in ACT 3 (ACT 4). If the position is inappropriate (YES in ACT 4), the control unit 310 moves the boundary 514 to an appropriate position (ACT 5).

If the position of the boundary 514 is appropriate in ACT 4 (NO in ACT 4), the control unit 310 skips ACT 5 and advances the processing to ACT 6.

The processing of ACTS 4 and 5 may be executed when the control unit 310 has a sufficient spare capacity. This processing may be omitted or postponed when the capacity of the control unit 310 is under strain.

Next, the control unit 310 performs a determination in ACT 6 based on the fourth information. In ACT 6, the control unit 310 determines whether the number of people waiting to use the self-service POS terminal 10 exceeds a threshold or not. If the number of people waiting exceeds the threshold in ACT 6 (YES in ACT 6), the control unit 310 takes a measure to cope with the people waiting (ACT 7). An example of a measure to cope with the people waiting is giving a guide about an available terminal via a speech or a text cue, or calling a salesclerk for assistance.

If the number of people waiting does not exceed the threshold in ACT 6 (NO in ACT 6), the control unit 310 skips ACT 7 and advances the processing to ACT 8.

The processing of ACTS 6 and 7 can be executed when the control unit 310 has a sufficient spare capacity. This processing is omitted when the capacity of the control unit 310 is under strain. The processing of ACTS 6 to 7 is given lower priority than the processing of ACTS 4 to 5. Therefore, when the spare capacity of the control unit 310 is insufficient, the processing of ACTS 6 to 7 is omitted first. If the spare capacity remains insufficient even then, the processing of ACTS 4 to 5 is omitted. That is, the processing of ACTS 4 to 5 is preferentially executed over the processing of ACTS 6 to 7.

Next, if the first information, that is, information representing the detection of non-registration, is output, the control unit 310 determines that non-registration is suspected (YES in ACT 8), then gives a notification to that effect (ACT 9), and ends this processing.

If the first information is not output in ACT 8, the control unit 310 determines that non-registration is not suspected (NO in ACT 8), and returns the processing to ACT 1.

In this way, according to this embodiment, the behavior detection processing to find out an inappropriate action by the operator in the sales data processing is executed with respect to the first area 511 only. Therefore, the load on the processing unit (control unit 310) performing the image analysis can be restrained, compared with the related art, where the entirety of the picked-up image 510 is analyzed.

Also, according to this embodiment, the position of the boundary 514 of the first area 511 can be optimized. Therefore, the behavior detection processing can be performed without excess or deficiency.

Moreover, according to this embodiment, the setting of the first area 511 can be optimized for each self-service POS terminal 10 through continuous use, instead of resetting the first area 511 on a per transaction basis.

In an embodiment, the server 300 is described as an example of the information processing device that analyzes a picked-up image from the camera 21. However, in other embodiments, the self-service POS terminal 10 may function as the information processing device. More specifically, the functional units (analysis unit 311, notification unit 312, adjustment unit 313) of the server 300 may be provided in the self-service POS terminal 10.

In an embodiment, the processing of ACTS 4 and 5 is performed following ACT 3. However, in other embodiments, processing of ACTS 4 and 5 may be not performed at this point but rather may be performed as a daily processing (once a day). For example, the processing of ACTS 4 to 5 may be performed at the startup of the device before the store is opened.

In an embodiment, the first area 511 is located at the center part of the picked-up image 510, and the adjustment unit 313 adjusts the position of the boundary 514 between the first area 511 and the other area. However, the location of the boundary 514 in some examples may be even partly at an edge of the picked-up image 510. That is, in some examples, the boundary 514 of the first area 511 may include an edge of the picked-up image 510.

The described aspects of the foregoing embodiments can also be applied to a semi-self-service-type POS terminal (an example of a payment device) where a shopper acts as an operator and performs an operation for settlement processing after merchandise registration. The registration processing before the settlement processing in this case can be performed, for example, via an operation by a salesclerk at a conventional POS terminal. In some other cases, the registration processing may be performed by the shopper himself or herself via the shopper's operation or the like to a POS application started up on a smartphone owned by the shopper or on a cart POS (terminal attached to a cart provided in the store).

The first embodiment can be carried out with a suitable modification by changing a part of a component or a function of each of the foregoing devices. Therefore, some modification examples according to the foregoing embodiment will now be described as other embodiments. In the description below, differences from the first embodiment are mainly described and the same parts as those already described are denoted by the same reference signs and not described further in detail. The modification examples given below may be carried out separately or may be carried out in a suitable combination with one another.

### Second Embodiment

The analysis unit 311 in the first embodiment analyzes the first area 511 and thus outputs the information about the movement of the operator as the first to third information. However, the analysis unit 311 in this second embodiment outputs information about the transition of the position of an item of merchandise. The information about the transition of the position of the merchandise is acquired by repeatedly executing image recognition on a moving item of merchandise in the picked-up image 510 and thus tracking the position of the merchandise.

The first information is information representing the detection of non-registration. The analysis unit 311 performs image recognition processing on the first area 511 in the picked-up image 510 and thus acquires the movement path of the recognized merchandise. Based on this movement path, the analysis unit 311 determines whether the merchandise has arrived at the post-registration storage place (bagging table 13) without passing through the position for accepting a registration operation (vicinity of the front of the scanner 16) from the pre-registration storage place (basket placing table 12) in the self-service POS terminal 10. If it can be determined that the merchandise has not passed through the position for accepting a registration operation while moving from the basket placing table 12 to the bagging table 13, the analysis unit 311 determines that non-registration is detected, and thus outputs the first information to that effect.

The second information is the number of times the merchandise recognized by the image recognition processing has moved beyond the boundary 514 to outside the first area 511. The analysis unit 311 counts the number and records the number in a predetermined area in the memory unit 304, or the like.

As the third information, the duration of a state where the merchandise recognized by the image recognition processing does not go beyond the imaginary line 516 set inside the first area 511 is measured and recorded in the memory unit 304, or the like.

Then, the adjustment unit 313 in this second embodiment makes an adjustment to broaden the first area 511 if it is determined that the frequency of occurrence of an event where the moving merchandise goes out beyond the boundary 514 is high based on the output from the analysis unit 311. Specifically, the adjustment unit 313 moves the boundary 514 to the predetermined position 515. The frequency is the number of times the event occurs within a predetermined period of time. If this frequency exceeds a predetermined threshold, it is determined that “the frequency is high”.

Also, if it is determined that a state where the moving merchandise does not go beyond the line 516 set within the boundary 514 continues, based on the output from the analysis unit 311, the adjustment unit 313 makes an adjustment to narrow the first area 511 to the line 516 (move the boundary 514 to the position of the line 516).

In the determination, the adjustment unit 313 determines that “the foregoing state continues”, for example, if the duration of the state where the moving merchandise does not go beyond the line 516 exceeds a predetermined threshold.

Thus, the information processing device according to the second embodiment can achieve effects similar to those of the foregoing embodiment.

The programs executed by each device in the foregoing embodiments can be incorporated in a ROM or the like in advance and provided in this form. The programs executed by each device in the foregoing embodiments may also be recorded as a file in an installable format or in an executable format, in a computer-readable recording medium such as a CD-ROM, a flexible disk (FD), a CD-R or a DVD (digital versatile disk) and provided in this form.

The programs executed by each device in the foregoing embodiments may also be stored in a computer connected to a network such as the internet and may be downloaded via the network and thus provided. The programs executed by each device in the foregoing embodiments may also be provided, accessed, or distributed via a network such as the internet.

The program executed by the information processing device according to an embodiment has a module configuration including the foregoing units (analysis unit 311, notification unit 312, adjustment unit 313). The CPU (processor) reads out the program from the memory device, executes the program, and thus implements the foregoing units. Thus, the analysis unit 311, the notification unit 312, and the adjustment unit 313 are generated.

While some embodiments have been described, these embodiments are presented simply as examples and are not intended to limit the scope of the present disclosure. These novel embodiments can be carried out in various other forms and can include various omissions, replacements, changes, and combinations without departing from the spirit and scope of the present disclosure. These embodiments and the modifications thereof are included in the spirit and scope of the present disclosure and also included in the scope of the claims and equivalents thereof.

What is claimed is:

1. An information processing device for image analysis of images from a camera positioned to image an operation at a checkout apparatus, the information processing device comprising:
a control unit configured to:
perform an analysis of a first sub-area of images from a camera to detect a movement of an operator or merchandise at a checkout apparatus;
output a notification of non-registration if the analysis of the first sub-area of the images indicates that an item of merchandise has arrived at a post-registration storage place of the checkout apparatus from a pre-registration storage place of the checkout apparatus without passing through a registration region; and
adjust a boundary position between the first sub-area and a periphery area in the images from the camera based on how often the operator or the merchandise is detected as crossing the boundary position.

2. The information processing device according to claim 1, wherein the control unit is configured to:
perform a behavior detection as the analysis of the first sub-area, and
move the boundary position to broaden the first sub-area if the frequency at which an arm or a hand of the operator moves across the boundary position exceeds a threshold level.

3. The information processing device according to claim 1, wherein the control unit is configured to:
perform a merchandise movement detection as the analysis of the first sub-area, and
move the boundary position to broaden the first sub-area if the frequency at which merchandise moves across the boundary position exceeds a threshold level.

4. The information processing device according to claim 1, wherein the control unit is configured to:
perform a behavior detection as the analysis of the first sub-area, and
move the boundary position to narrow the first sub-area if an arm or a hand of the operator does not cross the boundary position during a predetermined interval of time.

5. The information processing device according to claim 4, wherein the control unit is configured to:
move the boundary position to broaden the first sub-area if the frequency at which the arm or the hand of the operator moves across the boundary position exceeds a threshold level.

6. The information processing device according to claim 1, wherein the control unit is configured to:
perform a merchandise movement detection as the analysis of the first sub-area, and
move the boundary position to narrow the first sub-area if an item of merchandise does not cross the boundary position during a predetermined interval of time.

7. The information processing device according to claim 6, wherein the control unit is configured to:
move the boundary position to broaden the first sub-area if the frequency at which items of merchandise move across the boundary position exceeds a threshold level.

8. The information processing device according to claim 1, wherein the control unit is configured to:
analyze a second sub-area of the images, the second sub-area being adjacent to the first-sub area at the boundary position, to determine whether a person other than the operator is waiting to use the checkout apparatus.

9. The information processing device according to claim 8, wherein the control unit is configured to:
analyze the second sub-area of the images to determine the number of people other than the operator waiting to use the checkout apparatus.

10. An information processing method for image analysis of images from a camera positioned to image an operation at a checkout apparatus, the method comprising:
performing an analysis of a first sub-area of images from a camera to detect a movement of an operator or merchandise at a checkout apparatus;
outputting a notification of non-registration if the analysis of the first sub-area of the images indicates that an item of merchandise has arrived at a post-registration storage place of the checkout apparatus from a pre-registration storage place of the checkout apparatus without passing through a registration region; and
adjusting a boundary position between the first sub-area and a periphery area in the images from the camera based on how often the operator or the merchandise is detected as crossing the boundary position.

11. The information processing method according to claim 10, further comprising:
performing a behavior detection as the analysis of the first sub-area; and
moving the boundary position to broaden the first sub-area if the frequency at which an arm or a hand of the operator moves across the boundary position exceeds a threshold level.

12. The information processing method according to claim 10, further comprising:
performing a merchandise movement detection as the analysis of the first sub-area; and
moving the boundary position to broaden the first sub-area if the frequency at which merchandise moves across the boundary position exceeds a threshold level.

13. The information processing method according to claim 10, further comprising:
perform a behavior detection as the analysis of the first sub-area, and
move the boundary position to narrow the first sub-area if an arm or a hand of the operator does not cross the boundary position during a predetermined interval of time.

14. The information processing method according to claim 13, further comprising:
moving the boundary position to broaden the first sub-area if the frequency at which the arm or the hand of the operator moves across the boundary position exceeds a threshold level.

15. The information processing method according to claim 10, further comprising:
performing a merchandise movement detection as the analysis of the first sub-area; and
moving the boundary position to narrow the first sub-area if an item of merchandise does not cross the boundary position during a predetermined interval of time.

16. The information processing method according to claim 15, further comprising:
moving the boundary position to broaden the first sub-area if the frequency at which items of merchandise move across the boundary position exceeds a threshold level.

17. The information processing method according to claim 10, further comprising:
analyzing a second sub-area of the images, the second sub-area being adjacent to the first-sub area at the boundary position, to determine whether a person other than the operator is waiting to use the checkout apparatus.

18. The information processing method according to claim 17, further comprising:
analyzing the second sub-area of the images to determine the number of people other than the operator waiting to use the checkout apparatus.

19. A non-transitory, computer-readable storage medium storing program instructions which when executed by a control unit of an information processing apparatus causes the information processing apparatus to perform a method comprising:
performing an analysis of a first sub-area of images from a camera to detect a movement of an operator or merchandise at a checkout apparatus;
outputting a notification of non-registration if the analysis of the first sub-area of the images indicates that an item of merchandise has arrived at a post-registration storage place of the checkout apparatus from a pre-registration storage place of the checkout apparatus without passing through a registration region; and
adjusting a boundary position between the first sub-area and a periphery area in the images from the camera based on how often the operator or the merchandise is detected as crossing the boundary position.

20. The medium according to claim 19, the method further comprising:
performing a behavior detection as the analysis of the first sub-area; and
moving the boundary position to broaden the first sub-area if the frequency at which an arm or a hand of the operator moves across the boundary position exceeds a threshold level.
